(19) United States
(12) Patent Application Publication
(10) Pub. No.: US 2017/0228121 A1
(43) Pub. Date: Aug. 10, 2017

(54) WATCH FACE REPRESENTATION OF INTENT TIMELINE AND STATE AND INTENT ELEMENTS

(71) Applicant: Intel Corporation, Santa Clara, CA (US)

(72) Inventors: Michal Wosk, Tel-Aviv (IL); Gil Sharon, Even-Yehuda (IL); Merav Greenfeld, Ness-Ziona (IL); Avi Sharoni, Kfar-Saba (IL); Ronen Soffer, Tel-Aviv (IL); Ronen Ventura, Modiin (IL)

(73) Assignee: Intel Corporation, Santa Clara, CA (US)

(21) Appl. No.: 15/420,547

(22) Filed: Jan. 31, 2017

Related U.S. Application Data
(60) Provisional application No. 62/291,985, filed on Feb. 5, 2016.

(51) Int. Cl. G06F 3/0487; G04G 9/00; G06F 1/16; G06F 3/01; G06F 3/0482

(52) U.S. Cl. CPC G06F 3/0487; G06F 3/017; G06F 3/0482; G06F 1/163; G04G 9/00

(57) ABSTRACT

Systems, apparatuses and technology-based methods may provide for generating a graphic representation of a time sorted list of intents and presenting the graphic representation in a perimeter region of a watch face. In addition, a timeline associated with the graphic representation may align with an hour hand of the watch face. In one example, the graphic representation distinguishes between types of intents, shows a start time and end time of one or more intents and shows a status of one or more intents.

### CROSS-REFERENCE TO RELATED APPLICATIONS

The present application claims the benefit of priority to U.S. Provisional Patent Application No. 62/291,985, filed on Feb. 5, 2016.

### TECHNICAL FIELD

Embodiments generally relate to user interfaces. More particularly, embodiments relate to watch face representations of intent timelines.

### BACKGROUND

When an individual looks at a watch, the individual typically sees numbers representing hours and minutes. The individual may then begin a cognitive calculation process in order to unveil the meaning of the numbers. The cognitive calculation process may incorporate, for example, the following factors: current time—hours and minutes; user state—location, activity (walking, driving or stationary), availability, physical and mental state (hungry, tired), etc.; upcoming intents—as the individual remembers them or as presented in various intent sources (e.g., calendars, to-do lists, television/TV-guides, short messaging service/SMS messages, emails, etc.); external and temporal constraints—weather, traffic conditions, opening hours of places, etc. In conventional settings, the process may consume a considerable amount of cognitive resources, manual resources and time.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a watch face with a “State times Intent” (S×I) element;

FIGS. 2 and 3 are additional illustrations of examples of watch faces according to embodiments;

FIG. 4 is a block diagram of an example of an apparatus according to an embodiment;

FIGS. 5-11 are additional illustrations of examples of watch face transitions throughout an intent timeline according to embodiments;

FIG. 12 is an illustration of an example of a watch face that is divided into a plurality of partition areas according to an embodiment;

FIG. 13 is an illustration of an example of a watch face that indicates the amount of intents left for the day according to an embodiment;

FIG. 14 is an illustration of an example of a watch face that indicates intent accomplishments according to an embodiment;

FIG. 15 is a flowchart of an example of a method of operating an apparatus according to an embodiment; and

FIG. 16 is a block diagram of an example of a timepiece system according to an embodiment.

### DESCRIPTION OF EMBODIMENTS

For centuries, people have been using watches to determine the time. The motivation to know the time may be derived from substantial questions in the day-to-day lives of individuals. The questions might include, for example:

“Do I have a time to do the laundry before I need to leave for Dan's party?”

“How much time do I have for lunch? When does my next meeting start?”

“Is it time to leave and pick-up Ben from School?”

“How much time do I have until the game starts? Will I be able to be at home on time for it?”

“When do I need to take the cake out of the oven?”

“Will I have time to meet Dan in Palo Alto today?”

“How busy is my day going to be? How much time will I spend driving?”

This disclosure describes a system, apparatus and technology-based method to provide a new watch face user interface, which helps users easily and effectively determine answers for these questions.

Technology described herein may perform certain calculations digitally. Accordingly, the cognitive and manual resources that may be conventionally required from users in order to “compute” the meaning of time per their next intent are freed.

Understanding the Upcoming Intent and how it Interacts with the Current State of the User:

Technology described herein may take into account the state of the user and the constraints that affect upcoming intents. Therefore, the ability to spare the calculation of what the time that the user sees actually means is achieved. Moreover, the technology may automatically take into account how the factors interact and affect one other. Therefore, the solutions provide the user with the actual implication of each intent on the user's next steps. Accordingly, the user may not need to manually fill in the gap by checking each of the other intent sources, analyzing the other relevant factors, and calculating the implications.

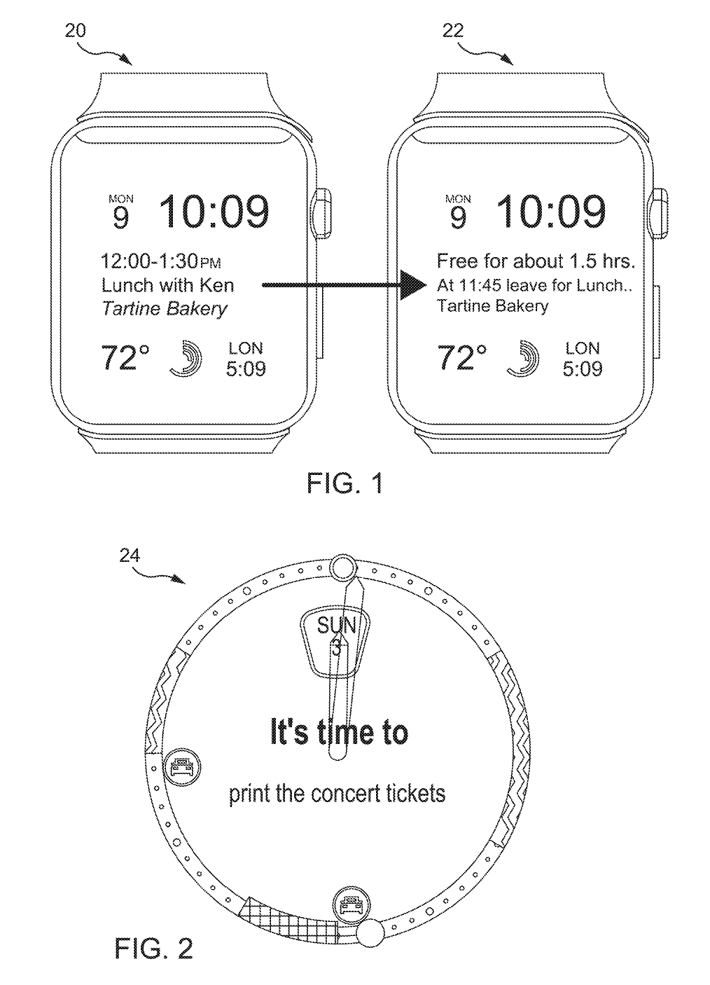

FIG. 1 shows an example of the advantages provided by this disclosure. In this case, an intent from a calendar—Lunch meeting downtown at 12:00 PM—is shown on a conventional watch 20. The current time is 10:09 AM and the user is currently at work. In this representation, the user may still need to determine the driving time to the destination, calculate when the user needs to leave in order to be there on time and understand if the user has enough time to, for example, start working on a report that is due before it is time to leave. By contrast, an enhanced timepiece system 22 shows what is presented if other factors such as the current user location and traffic conditions are taken into account. In this case, the meaning of the user's time is “You have 1.5 hrs until you need to leave to the meeting”.

The timepiece system 22 therefore provides a new way to present time. This new time representation is the most cohesive and relevant description of time for the user, as it aggregates all of the essential information from other relevant sources (e.g., digital and non-digital), and creates a conclusive message out of them.

The new time representation may also function as a “call for action” for the user. Part of the new time feature is the understanding that the call for action is a part of the user's day and may be an integral component of the watch face.

FIG. 2 is an example of a watch face 24 in which the user sets a reminder to print concert tickets at 12 PM. At 12 PM, the fact that the user needs to print the tickets is the real meaning of time for the user. The illustrated approach therefore generates a significantly higher value interface for the user, compared to a momentary, easily-dismissed reminder.

Obtaining a Full Picture of the Upcoming Day and where the User is in Relation to it:

Another advantage is associated with the fact that the meaning of time for people may not be merely about knowing the current time. The meaning may also be about where they are, what they are doing, and what they need to do during the day. When individuals look at the time, they may have many questions about their upcoming day. In order to obtain the answers, they might go to the relevant sources that manage the day's events for them (calendar apps, to-do lists, post-it on the fridge, etc.) and get from them a brighter picture about their day:

The Count—“How many meetings do I have today? “How many tasks do I have to complete today?

The Type—“Do I have any drives today?”, “Does the 6 PM meeting require driving to a location outside work?”, “Do I need to go someplace to complete the task I have?”

The Meaning—“Is it going to be a busy day?”, “When will my work day end today?”, “When is a good time to stop at Walmart to buy the light-bulb that I need?”

Technology described herein may aggregate different types of intents and present the full implication and the inter-dependency between these intents. Therefore, when a user wants to get a full understanding about the user's upcoming day (“The meaning” question above), the user does not need to consult several sources, cross reference the intents or mentally visualize the user's day under current solutions.

Indeed, the system described herein provides a clear and simple representation of the upcoming day on the watch face. This representation may give the user a sense of how the rest of the user's day is going to look in one quick glance. This view aggregates many intent types from different sources, and takes into account their implication and their inter-dependency. Accordingly, the system may automatically answer the meaningful questions that arise as users look at the time, in an informative and detailed, yet comprehensive and compact manner: How their day is going to look, what are the elements that the day is built from, and more. Below is an overview of the above techniques.

A Bottom Line—the “Actual Meaning of Time”

Presenting the user in one clear glance with the “actual meaning of time” for the user and providing essential information such as:

Leaving time for places;

Information about start and end time of events, as well as their duration;

Free time before the user needs to take an action;

Suggestions for when and how to fulfil intents;

Suggestions for how to make the most of the user's free time.

Timeline—Overlooking the Whole Day in One Quick Glance

Giving the user a sense of the user's upcoming day in one quick glance and helping the user answer questions such as:

Is the upcoming day busy or free?

How long will the user be at work today?

How much free time does the user have today?

When will the day end?

The watch face user interface:

The technology described herein presents the two elements above in a new “visual language” and user interface, which—in addition to presenting the time—supplies the user with an overview of the user's day and enables the user to easily understand what is going on at a given moment and in the future. This visual language and user interface may also offer interactions for the user that revolve around the user's intents, based on the user's current state.

The visual language presented herein includes a watch face and may be deployed in various form factors such as wrist bands, home clocks, vehicles, home appliances, etc.

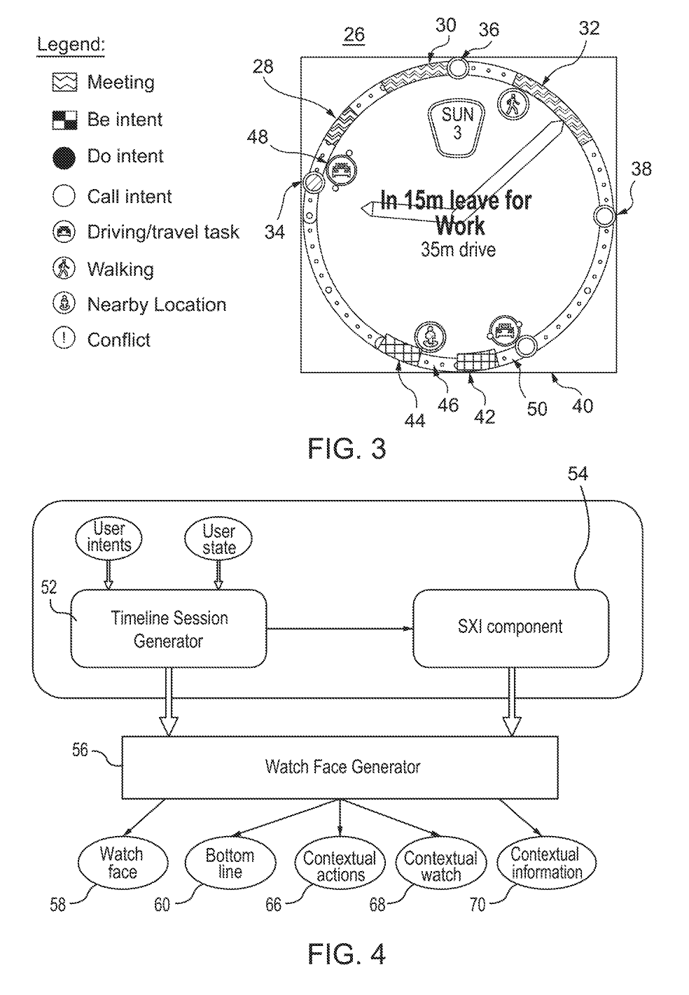

In FIG. 3, a watch face 26 provides an illustration of the visual language:

The current time is: 9:08 AM

The bottom line is: “In 15 m leave for Work, 35 m drive”

The planned intents:

Three meeting representations—a LOAM meeting representation 28, an 11 AM meeting representation 30 at work and a 1 PM meeting representation 32 in walking distance from work.

Call reminders—One call reminder 34 for when the user leaves for work or for the user's next drive

Three “To-Do” task representations—a 12 PM task representation 36, a 3 PM task representation 38, and another task representation 40 for when the user leaves work.

Two places to be representations—a 5:30 PM representation 42 and a 6:30 PM representation 44. Thus, the watch face 26 quickly conveys that in order to be at the first location on time, the user needs to leave work around 5 PM. Additionally, a proximity icon 46 conveys that the location for the 6:30 PM “Be” intent (e.g., location intent) is nearby the previous “Be” intent location.

Two planned drive representations—a first drive representation 48 to work and a second drive representation 50 from work to the 5:30 PM “Be” intent.

The watch face 26 therefore presents a new visual language that takes the traditional representation of time using the hour hand and overlays additional valuable information. More particularly, each of the intents may occupy a position on a single timeline that aligns with the hour hand. Hence, the user may receive a clear sense of the user's upcoming day based on the user's state (e.g., location, activity, availability) and the understanding of the user's upcoming day as it is obtained by the system.

The basic principle of the visual language is to take the user's timeline, which is a prioritized sequence of intents from different types and sources, and display them on the dials of the watch (e.g., in a perimeter region) based on their position on the time axis. This way, in one glance the user can have a clear sense about the upcoming day and the intents it beholds. The intents that comprise the view on the watch may be calendar meetings, places to be, calls to return, tasks to do, commutes and travels, TV shows or games that the user wants to watch, buses the user wants to catch, people the user wants to meet, and so forth. Using the hour hand of the watch, the user can have an understanding of what is going on at the moment and where the user is relative to the view of the day. Moreover, the user may make gestures such as, for example, rotating the bezel of the watch, in order to view activities for the entire day (e.g., given that the watch may only show AM or PM), as will be discussed in greater detail.

The visualization described above is complemented with a “bottom line” element, summarizing what the system knows about the user's current state (location, activity, which meeting the user is in, etc.) and how it affects the user's upcoming intent. For example: “Your spinning class ends in 20 minutes. You have 25 minutes to change in order to leave on time for dinner at Fu-sushi”. Combined together, these elements provide the user with a singular, clear, elegant and useful expression/visualization of the user's actual time.

As will be discussed in greater detail, the timeline and the bottom line elements may be complemented with contextual actions that help the user interact with the timepiece, obtain more information and receive quick assistance in fulfilling intents.

Richness of Intent Types Presented in One Glance

This solution presents many types of intents (such as meetings to attend, tasks to complete, calls to make, commutes and travels along the day, etc.) in a one glace view. Accordingly, gives the user gains a full sense about the upcoming day and where the user is relative to it.

The technology described herein may combine the following strengths:

A timeline that is rich with different types of intent from different/various intent sources such as, for example, meetings, travels, tasks, TV shows, phone calls, and so forth.

On the timeline, each intent is shown with its implication. For example, an upcoming meeting having a location that is different from the location of the meeting before it, may be presented with an appropriate travel task.

The intents may be ordered on the timeline as a continuous sequence, which enables the user to see the route of the user's day in one glance.

Provide a clear sense of how the user's day is going to look and an understanding of the sequence and inter-dependency between the user's intents.

The technology described herein combines these three axes together—richness of information, intersecting the information with the user current and predicted state, and clarity.

Contextual Actions—Determined According to the User State:

This disclosure provides a solution to one of the user interface (UI) challenges that is unique to a digital watch. The small real estate of the screen size may require showing only the most relevant information and providing a small number of interactions at a certain time. This disclosure offers a solution for this challenge by providing quick and relevant actions, based on the upcoming intent and the current state of the user.

This solution offers more contextual and advanced capabilities, including:

Showing only the more relevant actions at a certain time and adjusting them according to the user state.

The solution described herein offers users with the optimal option according the user state and the upcoming intent. More particularly, when it is determined that the user is on the way to the meeting and should arrive there on time, the assistance might be: “Notify attendees that you are on the way to the meeting.” In the case where there is heavy traffic on the way and the user is about to be late to the meeting, the suggested action may automatically change to: “Notify attendees that you are running late.” Moreover, when the user arrives to the meeting location, the suggested action may become: “Notify attendees that you have arrived.”

In addition, this system also understands who to notify based on the type of meeting and the identities of the most relevant stakeholders. The system may suggest smart relevant contextual snoozing options for each intent type such as: “remind me again when I am in the car/arrive home/on the way to San Jose,” etc.

Unique actions may be tailored to allow the user to express needs fully in the challenging real estate that the watch supplies, for example: contextual “later” option in case of a To-do reminder. The meaning of this “later” option may be determined according to the type of the intent and the other intents that the user has on a given day. In another example, a meeting “reschedule” option may adjust to the user's day and upcoming intents.

Bottom Line—Present Intents Relative to the User's Current State:

The bottom line element described herein is a simple and clear conclusion about the user's time that will enable the user to operate accordingly and avoid excessive manual calculations in the user's mind. For example, if the time is 11 AM and the next meeting starts at 3 PM, the bottom line element may take into account the location of the meeting and the user's current activity (e.g., when does the user needs to leave to get to the meeting on time).

This disclosure therefore presents the user with a bottom line that takes the user's current state into account and presents it in a meaningful way that reduces the need for manual calculations. In this case, a message such as: “Free for the next 3 hrs. Then, at 2 PM leave for the meeting, it will take you 55 min to drive there, meeting starts at 3 pm.” might be presented. This text takes into account the meeting starting time and the current time, and adds the meeting location, the distance of the user from that location, current traffic conditions, tasks that the user might complete on the way (e.g., filling gas in the user's car, etc.) and what the user needs to do in order to be there on time.

Interactive Actions on the Watch:

This disclosure presents unique watch gestures for various functionalities: moving forward and backwards on the timeline, viewing more data about the intent on the timeline, and inserting new intents to the timeline. These gestures will be described in greater detail.

As shown in FIG. 4, the watch face logic and the information that it displays may be implemented in an intent timeline apparatus 51 including two separate components:
a timeline session generator 52 that uses intent and state data to provide the sequence of intents that represent the user's upcoming day.
an S×I (State times Intent) component 54, which provides an insight about the user's upcoming intent as effected by the user's current state.

Watch Face Generator—the Visual Language:

A watch face generator 56 may receive the user's timeline session and continually or periodically create the graphic representation/visualization of the timeline on a watch face 58. The timeline may be separated into layers based on the different types of intent and the different elements on the timeline. For example, the different layers can be calendar meetings, “be” intent, tasks (call or to-do), travel tasks, conflicts between meeting locations, etc. Each layer may contain the intent start and end time and the status of this intent (active/non active). The watch face generator 56 may render the intents on the dials of the watch face 58 based on their position on the time axis. Each layer may also have its own color and texture.

The view may be updated every few minutes or every time that the timeline session is updated due to a new intent, removal of an intent, change in an intent status, change in user state, etc.

This visualization enables the user to obtain a sense of how the user's day is going to look: is it a busy or free day, how many travels are there going to be, how many free slots to complete tasks, etc.

The combination of this view and the position of the hour hand indicates where the user is relative to the user's intents. The meaning of the combination between the hour hand position and the information on the watch dial changes according to the intent type and the user state in relation to it.

Bottom Line:

The watch face generator 56 may also generate a bottom line 60 as an addition to the graphic illustration of the user's day on the watch. The bottom line 60 may give the user a clear useful description of the user's upcoming intent according to the day plan and how the user's current state impacts this intent. More particularly, the watch face generator 56 may convert a set of elements from the S×I component 54 into short descriptive text or other graphical representation(s) that describe the user's upcoming intent in light of the current state of the user. The bottom line 60 may therefore give the user an understanding of the implication of the current time on the user's day plan, so the user may act accordingly.

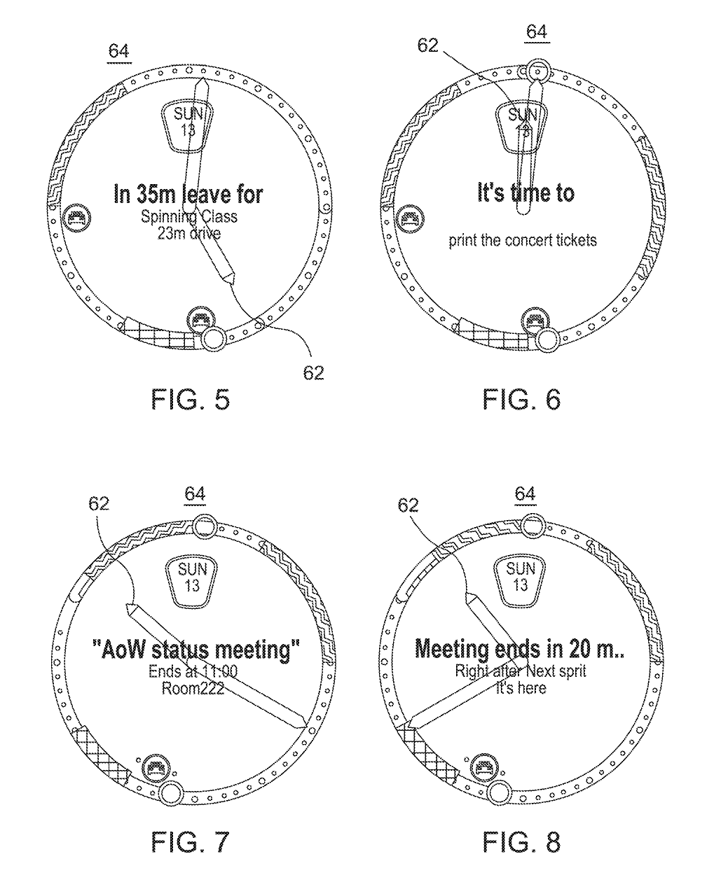

In FIG. 5, an hour hand 62 of a watch face 64 is positioned before a travel task. Meaning: The user has time before the user needs to leave.

In FIG. 6, the hour hand 62 points to a task. Meaning: It's time to do this task.

In FIG. 7, the hour hand 62 points to a meeting that started a few minutes ago. Meaning: The user is in the meeting that just started.

In FIG. 8, the hour hand 62 points to a meeting and the meeting is about to end. Meaning: The user is in this meeting and about it is about to end soon.

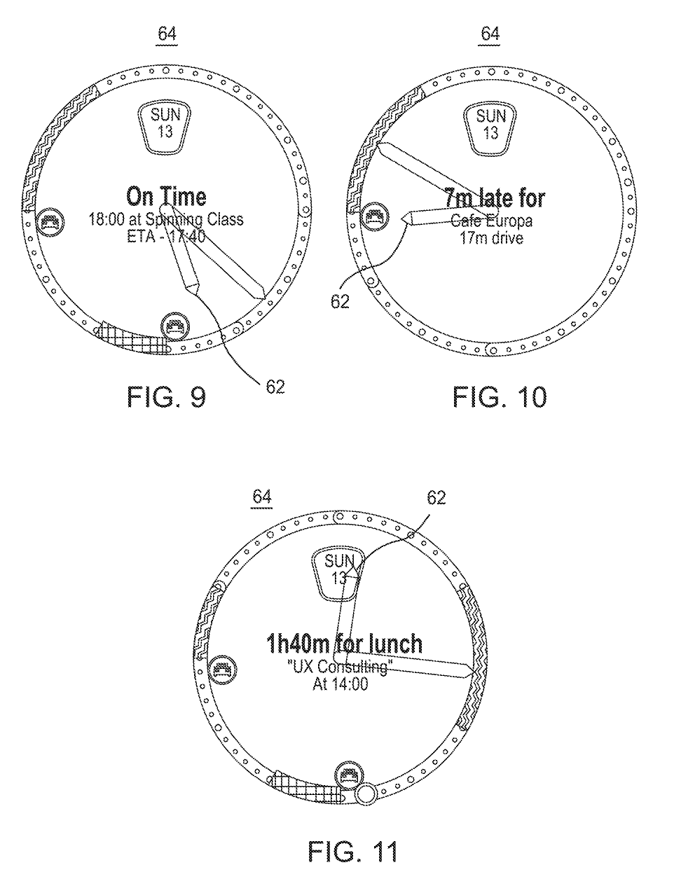

In FIG. 9, the hour hand 62 is positioned before a travel task and the travel task is active (e.g., illuminated). Meaning: The user is on the way and the user will arrive ahead of time.

In FIG. 10, the hour hand 62 points to the travel task and the travel task is not active (e.g., not illuminated), since the user is still not in the driving state. Meaning: If the user wants to be in the meeting on time the user should have already started driving there. Therefore, a conflict has arisen and the user is late. Other conflicts between intents may also be shown in the graphical representations on the watch face 64.

In FIG. 11, the hour hand 62 points to a place without an intent. Meaning: Free time, and in this case since it is lunch time, it is suggested as a good time for lunch.

Contextual Actions and Quick Assistance:

Returning now to FIG. 4, the illustrated watch face generator 56 also generates context actions 66, a contextual watch 68 and other contextual information to be displayed on the watch face 58. Thus, the watch face generator 56 may determine the user state and the S×I line and, based on a rule based logic, offer relevant actions. These actions may provide contextual relevant assistance such as: Navigate, notify late/on the way/arrived/not going, share, remove, delete, call now etc.

Some examples:
When the user has an upcoming travel task and the user is still not on the way there, the watch offers the “navigate” option.
According to user's expected arrival to a meeting, the user is offered a contextual notify option such as: “I'm late,” “I'm on the way,” “I'm nearby,” “I'm already here,” etc.
For an upcoming meeting, the user may be offered an option to mark the meeting as “not going,” which will remove the meeting from the user's timeline and notify the attendees that the user is not going to attend.
In a quick “reschedule” option for meetings, one tap/click might schedule the meeting taking into account the schedules of the user and the other attendees and their availability, locations and other state elements.
All reminders may be offered with a “later” option as a snooze option for the reminder. When the snoozing option is selected, the timeline session generator 52 may find the best contextual time to set the reminder, according to its type, and send it back to the watch face generator 56 to present it with the new time.
Whenever a call reminder is triggered, the user may be prompted with an option to make the call.

The intent timeline apparatus 51 may include logic instructions, configurable logic, fixed-functionality logic hardware, etc., or any combination thereof.

Unique Gestures:

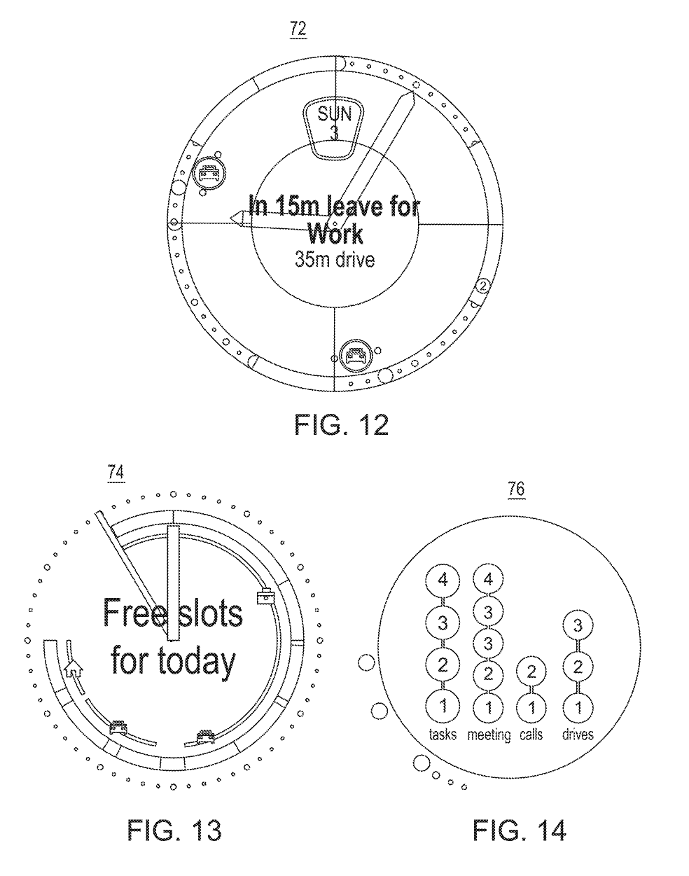

Due to the small screen size of the watch, the system may detect unique gestures that enable the user to naturally and comfortably interact with the watch to get more views, details, add, edit or delete items, etc.
Future intents may be viewed by rotating the watch's bezel or by pulling the dial backwards or forwards. In response, the watch face may present the past or future intents respectively.
A new intent may be inserted by dragging a newly created intent (task or place to be) into the desired time on the timeline.
Intent details may be viewed (e.g., due to the small screen size) by tapping on the timeline intent. FIG. 12 demonstrates that in this concept, a watch face 72 is split into four quarters (e.g., defining partition areas), a size that is more fit to a human finger. Pressing on one of the quarters may trigger the display of the details of the intents within the timespan covered by the quarter in question. Because the number of partition areas may depend on the screen size and screen resolution, in some cases it is possible to define to more than four partition areas.

More Views:

From the main watch face, the user is able to access more watch faces that provide advanced perspectives on the user's day. These views may support more user needs such as:
Determining the amount of intents still left for the day—“how many meetings today”, “how many call meetings”, “how many travels will I do”, “how many tasks and calls to return”, “what are my free slots”, etc. FIG. 13 illustrates a watch face 74 that includes one of these views: the free slots that the user has during the user's day.
Intent accomplishment—“how many meetings have I already attended today”, “how many tasks did I complete”, etc. FIG. 14 illustrates a watch face 76 that includes this view.

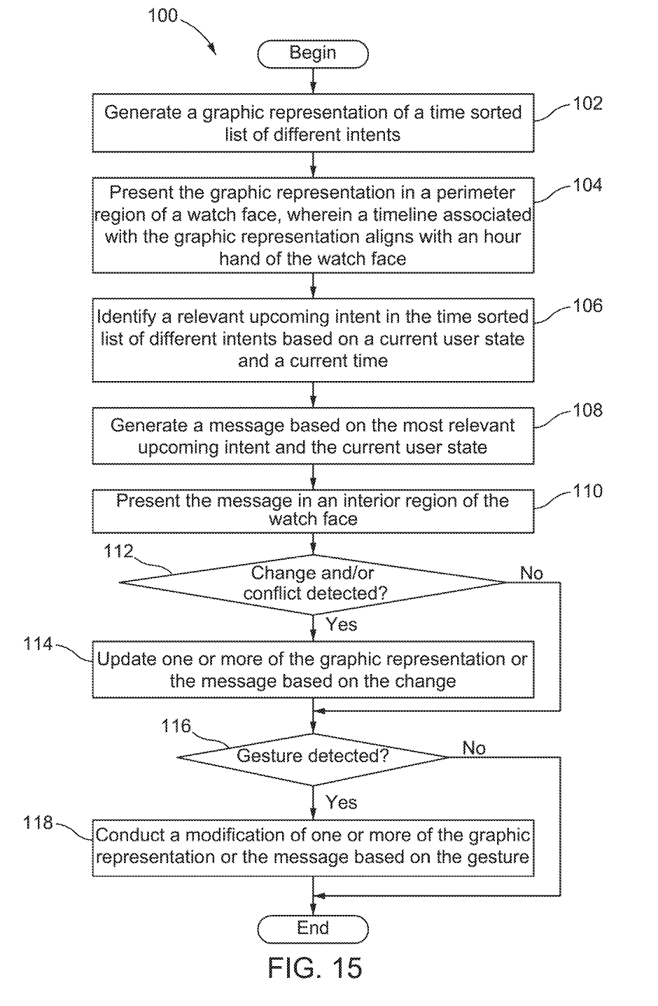

FIG. 15 shows a method 100 of operating an intent timeline apparatus. The method 100 may generally be implemented in a timepiece system including an intent timeline apparatus such as, for example the apparatus 51 (FIG. 4), already discussed. More particularly, the method 100 may be implemented in one or more modules as a set of logic instructions stored in a machine- or computer-readable storage medium such as random access memory (RAM), read only memory (ROM), programmable ROM (PROM), flash memory, etc., as configurable logic such as, for example, programmable logic arrays (PLAs), field programmable gate arrays (FPGAs), complex programmable logic devices (CPLDs), as fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 100 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 102 provides for generating a graphic representation of a time sorted list of different/various intents, wherein the use of time sorted lists of intent as described herein may improve computer functionality to the extent that the timepiece system operates more efficiently and provides an enhanced user experience. Additionally, the graphic representation may be presented in a perimeter region of a watch face at block 104. In the illustrated example, a timeline associated with the graphic representation aligns with an hour hand of the watch face. Moreover, the graphic representation may distinguish between types of intents, show a start time and end time of one or more intents, show a status of one or more intents and show conflicts between intents. Additionally, block 106 may identify a relevant upcoming intent in the time sorted list of different intents based on a current user state and a current time. In one example, block 106 includes computing an S×I (State times Intent) element from the user's current state and the user's upcoming intent(s). Rather than a most relevant upcoming intent, block 106 might identify an upcoming intent that is simply more relevant than another upcoming intent (e.g., based on relative priorities and/or weights assigned by the user to different types of intents). Block 108 may generate a message based on the relevant upcoming intent and the current user state, wherein the message may be presented in an interior region of the watch face at block 110. In one example, the message includes a recommended course of action (e.g., based on the current user state and an upcoming intent).

A determination may be made at block 112 as to whether one or more of a change in user state, a change in intent or a conflict between intents is detected. If so, the graphic representation and/or the message may be updated at block 114 based on the change/conflict. Otherwise, the method 100 may bypass block 114. In addition, a determination may be made at block 116 as to whether a gesture has been detected. If so, illustrated block 118 conducts a modification of one or more of the graphic representation or the message based on the gesture. Block 116 may also include defining a plurality of partition areas on the watch face and determining that the gesture is associated with a particular area in the plurality of partition areas. In such a case, the modification at block 118 may be conducted with respect to the particular area. If a gesture is not detected at block 116, the method 100 may bypass block 118 and terminate.

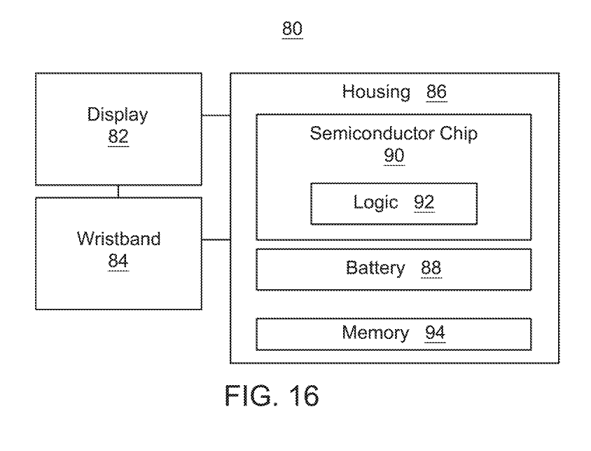

FIG. 16 shows a timepiece system 80 that includes a display 82 to visually present a watch face, a wristband 84 and a housing 86 coupled to the display 82 and the wristband 84. The illustrated housing 86 includes a battery 88 to supply power to the timepiece system 80, a memory 94 (e.g., non-volatile memory/NVM, volatile memory, or other non-transitory computer readable storage medium) and a semiconductor chip 90. The semiconductor chip 90 may include a substrate (e.g., silicon, not shown) and logic 92 configured to perform one or more aspects of the method 100 (FIG. 15), already discussed. The logic 92 may also include the apparatus 51 (FIG. 4), already discussed. Thus, the logic 92 may generate a graphic representation of a time sorted list of different intents and present the graphic representation in a perimeter region of the watch face, wherein a time line associated with the graphic representation aligns with an hour hand of the watch face.

As already noted, the graphic representation may distinguish between types of intents. The graphic representation may also show a start time and end time of one or more intents. Additionally, the graphic representation may show a status of one or more intents. Moreover, the graphic representation may show conflicts between intents.

The logic 92 may also identify a relevant upcoming intent in the time sorted list of different intents based on a current user state and a current time, generate a message (e.g., a recommended course of action) based on the relevant upcoming intent and the current user state, and present the message in an interior region (e.g., “bottom line”) of the watch face. In one example, the graphic representation and/or the message are updated by the logic 92 based on a change in user state, a change in intent and/or a conflict between intents.

The logic 92 may also detect gestures and conduct modifications of the graphic representation and/or the message based on the gestures. Additionally, the logic 92 may define a plurality of partition areas on the watch face and determine that the gesture is associated with a particular area in the plurality of partition areas. In such a case, the modification may be conducted with respect to the particular area.

In one example, the logic 92 includes configurable logic such as, for example, PLAs, FGPAs, CPLDs, and so forth. In another example, the logic 92 includes fixed-functionality logic hardware such as, for example, ASIC technology, CMOS technology, TTL technology, and so forth. In yet another example, the logic 92 includes logic instructions retrieved from the memory 94 and executed on one or more processor cores of the semiconductor chip 90. In still another example, the logic 92 includes a combination of configurable logic (e.g., a FGPA) that performs a first portion of the method 100 (FIG. 15) and fixed-functionality logic hardware (e.g., an ASIC) that performs a second portion of the method 100 (FIG. 15), etc.

### Additional Notes and Examples

Example 1 may include a timepiece system comprising a display to visually present a watch face, a wristband, a housing coupled to the display and the wristband, and a semiconductor chip positioned within the housing, the semiconductor chip including logic to generate a graphic representation of a time sorted list of different intents and present the graphic representation in a perimeter region of the watch face, wherein a timeline associated with the graphic representation aligns with an hour hand of the watch face.

Example 2 may include the system of claim 1, wherein the graphic representation is to distinguish between types of intents, show a start time and end time of one or more intents, show a status of one or more intents and show conflicts between intents.

Example 3 may include the system of any one of claim 1 or 2, wherein the logic is to may include the identify a relevant upcoming intent in the time sorted list of different intents based on a current user state and a current time, generate a message based on the relevant upcoming intent and the current user state, present the message in an interior region of the watch face, and update one or more of the graphic representation or the message based on one or more of a change in user state, a change in intent or a conflict between intents.

Example 4 may include the system of claim 3, wherein the message is to include a recommended course of action based on the current user state and an upcoming intent.

Example 5 may include the system of claim 3, wherein the logic is to may include the detect a gesture, and conduct a modification of one or more of the graphic representation or the message based on the gesture.

Example 6 may include the system of claim 5, wherein the logic is to may include the define a plurality of partition areas on the watch face, and determine that the gesture is associated with a particular area in the plurality of partition areas, wherein the modification is conducted with respect to the particular area.

Example 7 may include a semiconductor chip apparatus comprising may include the logic, implemented at least partly in one or more of configurable logic or fixed-functionality logic hardware, to may include the generate a graphic representation of a time sorted list of different intents, and present the graphic representation in a perimeter region of a watch face, wherein a timeline associated with the graphic representation aligns with an hour hand of the watch face.

Example 8 may include the apparatus of claim 7, wherein the graphic representation is to distinguish between types of intents, show a start time and end time of one or more intents, show a status of one or more intents and show conflicts between intents.

Example 9 may include the apparatus of any one of claim 7 or 8, wherein the logic is to may include the identify a relevant upcoming intent in the time sorted list of different intents based on a current user state and a current time, generate a message based on the relevant upcoming intent and the current user state, present the message in an interior region of the watch face, and update one or more of the graphic representation or the message based on one or more of a change in user state, a change in intent or a conflict between intents.

Example 10 may include the apparatus of claim 9, wherein the message is to include a recommended course of action based on the current user state and an upcoming intent.

Example 11 may include the apparatus of claim 9, wherein the logic is to may include the detect a gesture, and conduct a modification of one or more of the graphic representation or the message based on the gesture.

Example 12 may include the apparatus of claim 11, wherein the logic is to may include the define a plurality of partition areas on the watch face, and determine that the gesture is associated with a particular area in the plurality of partition areas, wherein the modification is conducted with respect to the particular area.

Example 13 may include a method of operating a semiconductor chip apparatus, comprising may include the generating a graphic representation of a time sorted list of different intents, and presenting the graphic representation in a perimeter region of a watch face, wherein a timeline associated with the graphic representation aligns with an hour hand of the watch face.

Example 14 may include the method of claim 13, wherein the graphic representation distinguishes between types of intents, shows a start time and end time of one or more intents, shows a status of one or more intents and shows conflicts between intents.

Example 15 may include the method of any one of claim 13 or 14, further including may include the identifying a relevant upcoming intent in the time sorted list of different intents based on a current user state and a current time, generating a message based on the relevant upcoming intent and the current user state, presenting the message in an interior region of the watch face, and updating one or more of the graphic representation or the message based on one or more of a change in user state, a change in intent or a conflict between intents.

Example 16 may include the method of claim 15, wherein the message includes a recommended course of action based on the current user state and an upcoming intent.

Example 17 may include the method of claim 15, further including may include the detecting a gesture, and conducting a modification of one or more of the graphic representation or the message based on the gesture.

Example 18 may include the method of claim 17, further including may include the defining a plurality of partition areas on the watch face, and determining that the gesture is associated with a particular area in the plurality of partition areas, wherein the modification is conducted with respect to the particular area.

Example 19 may include at least one computer readable storage medium comprising a set of instructions, which when executed by a timepiece system, cause the timepiece system to may include the generate a graphic representation of a time sorted listed of different intents, and present the graphic representation in a perimeter region of a watch face, wherein a timeline associated with the graphic representation aligns with an hour hand of the watch face.

Example 20 may include the at least one computer readable storage medium of claim 19, wherein the graphic representation is to distinguish between types of intents, show a start time and end time of one or more intents, show a status of one or more intents and show conflicts between intents.

Example 21 may include the at least one computer readable storage medium of any one of claim 19 or 20, wherein the instructions, when executed, cause the timepiece system to may include the identify a relevant upcoming intent in the time sorted list of different intents based on a current user state and a current time, generate a message based on the relevant upcoming intent and the current user state, present the message in an interior region of the watch face, and update one or more of the graphic representation or the message based on one or more of a change in user state, a change in intent or a conflict between intents.

Example 22 may include the at least one computer readable storage medium of claim 21, wherein the message is to include a recommended course of action based on the current user state and an upcoming intent.

Example 23 may include the at least one computer readable storage medium of claim 21, wherein the instructions, when executed, cause the timepiece system to may include the detect a gesture, and conduct a modification of one or more of the graphic representation or the message based on the gesture.

Example 24 may include the at least one computer readable storage medium of claim 21, wherein the instructions, when executed, cause the timepiece system to may include the define a plurality of partition areas on the watch face, and determine that the gesture is associated with a particular area in the plurality of partition areas, wherein the modification is conducted with respect to the particular area.

Example 25 may include a semiconductor chip apparatus comprising may include the means for generating a graphic representation of a time sorted list of different intents, and means for presenting the graphic representation in a perimeter region of a watch face, wherein a timeline associated with the graphic representation is to align with an hour hand of the watch face.

Example 26 may include the apparatus of claim 25, wherein the graphic representation is to distinguish between types of intents, shows a start time and end time of one or more intents, shows a status of one or more intents and shows conflicts between intents.

Example 27 may include the apparatus of any one of claim 25 or 26, further including may include the means for identifying a relevant upcoming intent in the time sorted list of different intents based on a current user state and a current time, means for generating a message based on the relevant upcoming intent and the current user state, means for presenting the message in an interior region of the watch face, and means for updating one or more of the graphic representation or the message based on one or more of a change in user state, a change in intent or a conflict between intents.

Example 28 may include the apparatus of claim 27, wherein the message is to include a recommended course of action based on the current user state and an upcoming intent.

Example 29 may include the apparatus of claim 27, further including may include the means for detecting a gesture, and means for conducting a modification of one or more of the graphic representation or the message based on the gesture.

Example 30 may include the apparatus of claim 29, further including may include the means for defining a plurality of partition areas on the watch face, and means for determining that the gesture is associated with a particular area in the plurality of partition areas, wherein the modification is conducted with respect to the particular area.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system comprising:
a display to visually present a watch face;
a wristband;
a housing coupled to the display and the wristband; and
a semiconductor chip positioned within the housing, the semiconductor chip including logic to:
generate a graphic representation of a time sorted list of different intents, and
present the graphic representation in a perimeter region of the watch face, wherein a timeline associated with the graphic representation aligns with an hour hand of the watch face.

2. The system of claim 1, wherein the graphic representation is to distinguish between types of intents, show a start time and end time of one or more intents, show a status of one or more intents and show conflicts between intents.

3. The system of claim 1, wherein the logic is to:
identify a relevant upcoming intent in the time sorted list of different intents based on a current user state and a current time,
generate a message based on the relevant upcoming intent and the current user state,
present the message in an interior region of the watch face, and
update one or more of the graphic representation or the message based on one or more of a change in user state, a change in intent or a conflict between intents.

4. The system of claim 3, wherein the message is to include a recommended course of action based on the current user state and an upcoming intent.

5. The system of claim 3, wherein the logic is to:
detect a gesture, and
conduct a modification of one or more of the graphic representation or the message based on the gesture.

6. The system of claim 5, wherein the logic is to:
define a plurality of partition areas on the watch face; and
determine that the gesture is associated with a particular area in the plurality of partition areas, wherein the modification is conducted with respect to the particular area.

7. An apparatus comprising:
logic, implemented at least partly in one or more of configurable logic or fixed-functionality logic hardware, to:
generate a graphic representation of a time sorted list of different intents, and
present the graphic representation in a perimeter region of a watch face, wherein a timeline associated with the graphic representation aligns with an hour hand of the watch face.

8. The apparatus of claim 7, wherein the graphic representation is to distinguish between types of intents, show a start time and end time of one or more intents, show a status of one or more intents and show conflicts between intents.

9. The apparatus of claim 7, wherein the logic is to:
identify a relevant upcoming intent in the time sorted list of different intents based on a current user state and a current time,
generate a message based on the relevant upcoming intent and the current user state,
present the message in an interior region of the watch face, and
update one or more of the graphic representation or the message based on one or more of a change in user state, a change in intent or a conflict between intents.

10. The apparatus of claim 9, wherein the message is to include a recommended course of action based on the current user state and an upcoming intent.

11. The apparatus of claim 9, wherein the logic is to:
detect a gesture, and
conduct a modification of one or more of the graphic representation or the message based on the gesture.

12. The apparatus of claim 11, wherein the logic is to:
define a plurality of partition areas on the watch face; and
determine that the gesture is associated with a particular area in the plurality of partition areas, wherein the modification is conducted with respect to the particular area.

13. A method comprising:
generating a graphic representation of a time sorted list of different intents; and
presenting the graphic representation in a perimeter region of a watch face, wherein a timeline associated with the graphic representation aligns with an hour hand of the watch face.

14. The method of claim 13, wherein the graphic representation distinguishes between types of intents, shows a start time and end time of one or more intents, shows a status of one or more intents and shows conflicts between intents.

15. The method of claim 13, further including:
identifying a relevant upcoming intent in the time sorted list of different intents based on a current user state and a current time;
generating a message based on the relevant upcoming intent and the current user state;
presenting the message in an interior region of the watch face; and
updating one or more of the graphic representation or the message based on one or more of a change in user state, a change in intent or a conflict between intents.

16. The method of claim 15, wherein the message includes a recommended course of action based on the current user state and an upcoming intent.

17. The method of claim 15, further including:
detecting a gesture; and
conducting a modification of one or more of the graphic representation or the message based on the gesture.

18. The method of claim 17, further including:
defining a plurality of partition areas on the watch face; and
determining that the gesture is associated with a particular area in the plurality of partition areas, wherein the modification is conducted with respect to the particular area.

19. At least one computer readable storage medium comprising a set of instructions, which when executed by a timepiece system, cause the timepiece system to:
generate a graphic representation of a time sorted listed of different intents; and
present the graphic representation in a perimeter region of a watch face, wherein a timeline associated with the graphic representation aligns with an hour hand of the watch face.

20. The at least one computer readable storage medium of claim 19, wherein the graphic representation is to distinguish between types of intents, show a start time and end time of one or more intents, show a status of one or more intents and show conflicts between intents.

21. The at least one computer readable storage medium of claim 19, wherein the instructions, when executed, cause the timepiece system to:
identify a relevant upcoming intent in the time sorted list of different intents based on a current user state and a current time;
generate a message based on the relevant upcoming intent and the current user state;
present the message in an interior region of the watch face; and
update one or more of the graphic representation or the message based on one or more of a change in user state, a change in intent or a conflict between intents.

22. The at least one computer readable storage medium of claim 21, wherein the message is to include a recommended course of action based on the current user state and an upcoming intent.

23. The at least one computer readable storage medium of claim 21, wherein the instructions, when executed, cause the timepiece system to:
detect a gesture; and
conduct a modification of one or more of the graphic representation or the message based on the gesture.

24. The at least one computer readable storage medium of claim 21, wherein the instructions, when executed, cause the timepiece system to:
define a plurality of partition areas on the watch face; and
determine that the gesture is associated with a particular area in the plurality of partition areas, wherein the modification is conducted with respect to the particular area.
